(19) United States
(12) Patent Application Publication
(10) Pub. No.: US 2024/0356870 A1
(43) Pub. Date: Oct. 24, 2024

(54) SYSTEMS AND METHODS FOR MESSAGE AUTOMATION

(71) Applicant: YAHOO ASSETS LLC, New York, NY (US)

(72) Inventors: Bassem BOUGUERRA, Long Beach, CA (US); Kevin PATEL, Fremont, CA (US); Shashank KHANNA, Fremont, CA (US); Shiv Shankar SAHADEVAN, San Jose, CA (US)

(21) Appl. No.: 18/476,439

(22) Filed: Sep. 28, 2023

Related U.S. Application Data
(60) Provisional application No. 63/497,944, filed on Apr. 24, 2023.

(51) Int. Cl. H04L 51/02; G06Q 10/1093; H04L 51/046

(52) U.S. Cl. CPC H04L 51/02; G06Q 10/1095; H04L 51/046

(57) ABSTRACT

In some implementations, the techniques described herein relate to a method including: (i) identifying, by a processor, an electronic message that comprises content generated by a user, (ii) predicting, by the processor, a potential action for the user by inputting the content of the electronic message into a large language model, (iii) suggesting, by the processor, the potential action to the user, (iv) receiving, by the processor, user input related to the potential action, and (v) performing, by the processor, on behalf of the user, a subsequent action conforming to the user input.

### CROSS-REFERENCE TO RELATED APPLICATIONS

This application claims the benefit of Provisional Patent Application No. 63/497,944, filed on Apr. 24, 2023, which is hereby incorporated by reference in its entirety.

### BACKGROUND

In a busy world, a user can often be overwhelmed with distractions from email messages, calls, and notifications from a hundred different apps. Users do not have time to interact with all of these systems on a day to day basis, and instead of the technology creating convenience, it becomes a burden. Accordingly, this disclosure suggests improved systems and methods for performing message automation.

### BRIEF DESCRIPTION OF THE DRAWINGS

FIG. 1 is a block diagram illustrating a system for performing message automation according to some of the example embodiments.

FIG. 2 is a flow diagram illustrating a method for performing message automation according to some of the example embodiments.

FIG. 3 is an illustration of an example of message automation according to some of the example embodiments.

FIG. 4 is a flow diagram illustrating a method message automation according to some of the example embodiments.

FIG. 5 is a block diagram of a computing device according to some embodiments of the disclosure.

### DETAILED DESCRIPTION

Various machine learning (ML) and artificial intelligence (AI) models are capable of analyzing and/or generating text. One example of such a model is a large language model (LLM). An LLM is a statistical model that predicts the next word in a sequence, given the previous words (often referred to as a “prompt”). LLMs are trained on massive datasets of text, and can be used for a variety of tasks, such as text generation, translation, and question answering. LLMs are typically composed of a neural network with many parameters (typically billions of weights or more). The neural network is trained on a large dataset of text and learns to predict the next word in a sequence, given the previous words. While LLMs are used primarily in the following description, the embodiments described herein can apply equally to other types of text generation models including, but not limited to, long short-term memory (LSTM) models, recurrent neural networks (RNNs), encoder-decoder models, transformer-based models, specialized convolutional neural networks (CNNs) and the like.

The example embodiments herein describe methods, computer-readable media, device, and systems that take an email that a user is composing or has just sent as input to an LLM and output one or more suggested actions. In some examples, a user may agree to a suggested action and the LLM may carry out the action. For example, an LLM may send a follow-up email, create a calendar event, and so forth.

In some implementations, the techniques described herein relate to a method including: (i) identifying, by a processor, an electronic message that comprises content generated by a user, (ii) predicting, by the processor, a potential action for the user by inputting the content of the electronic message into an LLM, (iii) suggesting, by the processor, the potential action to the user, (iv) receiving, by the processor, user input related to the potential action, and (v) performing, by the processor, on behalf of the user, a subsequent action conforming to the user input.

In some implementations, the techniques described herein relate to a method, wherein identifying the electronic messages comprises identifying an electronic message sent by the user.

In some implementations, the techniques described herein relate to a method, wherein identifying the electronic messages comprises identifying an electronic message being composed by the user that has not yet been sent.

In some implementations, the techniques described herein relate to a method, receiving user input related to the potential action comprises receiving a modification of the potential action provided by the user via a chat interface and generating a new potential action using the large language model, wherein performing the subsequent action comprises performing the new potential action.

In some implementations, the techniques described herein relate to a method, wherein performing the subsequent action comprises creating a digital calendar event on behalf of the user.

In some implementations, the techniques described herein relate to a method, wherein performing the subsequent action comprises sending an additional electronic message on behalf of the user.

In some implementations, the techniques described herein relate to a method, wherein performing the subsequent action comprises creating additional content and adding the additional content to the electronic message.

In some implementations, the techniques described herein relate to a method, wherein suggesting the potential action to the user comprises generating, by the large language model, a description of the potential action and displaying the description in a user interface.

In some implementations, the techniques described herein relate to a non-transitory computer-readable storage medium for tangibly storing computer program instructions capable of being executed by a computer processor, the computer program instructions defining steps of: (i) identifying, by a processor, an electronic message that comprises content generated by a user, (ii) predicting, by the processor, a potential action for the user by inputting the content of the electronic message into an LLM, (iii) suggesting, by the processor, the potential action to the user, (iv) receiving, by the processor, user input related to the potential action, and (v) performing, by the processor, on behalf of the user, a subsequent action conforming to the user input.

In some implementations, the techniques described herein relate to a non-transitory computer-readable storage medium, wherein identifying the electronic messages comprises identifying an electronic message sent by the user.

In some implementations, the techniques described herein relate to a non-transitory computer-readable storage medium, wherein identifying the electronic messages comprises identifying an electronic message being composed by the user that has not yet been sent.

In some implementations, the techniques described herein relate to a non-transitory computer-readable storage medium, receiving user input related to the potential action comprises receiving a modification of the potential action provided by the user via a chat interface and generating a new potential action using the large language model, wherein performing the subsequent action comprises performing the new potential action.

In some implementations, the techniques described herein relate to a non-transitory computer-readable storage medium, wherein performing the subsequent action comprises creating a digital calendar event on behalf of the user.

In some implementations, the techniques described herein relate to a non-transitory computer-readable storage medium, wherein performing the subsequent action comprises sending an additional electronic message on behalf of the user.

In some implementations, the techniques described herein relate to a non-transitory computer-readable storage medium, wherein performing the subsequent action comprises creating additional content and adding the additional content to the electronic message.

In some implementations, the techniques described herein relate to a non-transitory computer-readable storage medium, wherein suggesting the potential action to the user comprises generating, by the large language model, a description of the potential action and displaying the description in a user interface.

In some implementations, the techniques described herein relate to a device including: a processor; and a storage medium for tangibly storing thereon logic for execution by the processor, the logic including instructions for: (i) identifying, by the processor, an electronic message that comprises content generated by a user, (ii) predicting, by the processor, a potential action for the user by inputting the content of the electronic message into an LLM, (iii) suggesting, by the processor, the potential action to the user, (iv) receiving, by the processor, user input related to the potential action, and (v) performing, by the processor, on behalf of the user, a subsequent action conforming to the user input.

In some implementations, the techniques described herein relate to a device, wherein identifying the electronic messages comprises identifying an electronic message sent by the user.

In some implementations, the techniques described herein relate to a device, wherein identifying the electronic messages comprises identifying an electronic message being composed by the user that has not yet been sent.

In some implementations, the techniques described herein relate to a device, receiving user input related to the potential action comprises receiving a modification of the potential action provided by the user via a chat interface and generating a new potential action using the large language model, wherein performing the subsequent action comprises performing the new potential action.

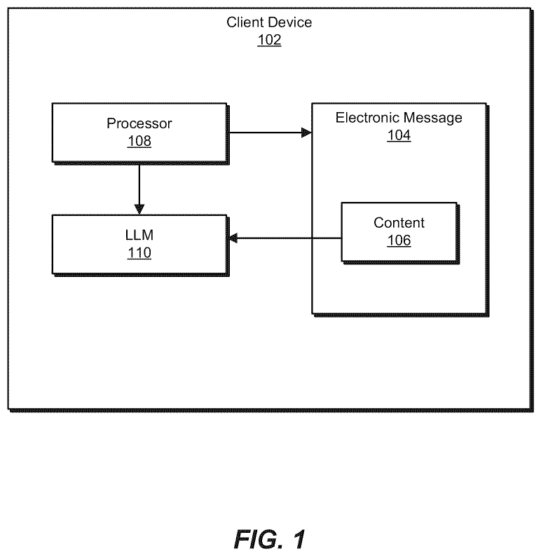

FIG. 1 is a block diagram illustrating a system for performing message automation according to some of the example embodiments.

The illustrated system includes a client device 102. Client device 102 may host a processor 108 identifies an electronic message 104 that includes content 106 written by a user. In some implementations, client device 102 may be configured with or otherwise be in communication with an LLM 110 that predicts, in response to being provided with content 106 of electronic message 104, a potential action for the user. In one implementation, one or more systems on client device 102 may suggest the potential action to the user and receive user input related to the potential action. In response, processor 108 may (via various agents, including in some examples LLM 110) perform the potential action on behalf of the user. Although illustrated here on client device 102, any or all of the systems described herein may be hosted by one or more servers and/or cloud based processing resources. Further details of these components are described herein and in the following flow diagrams.

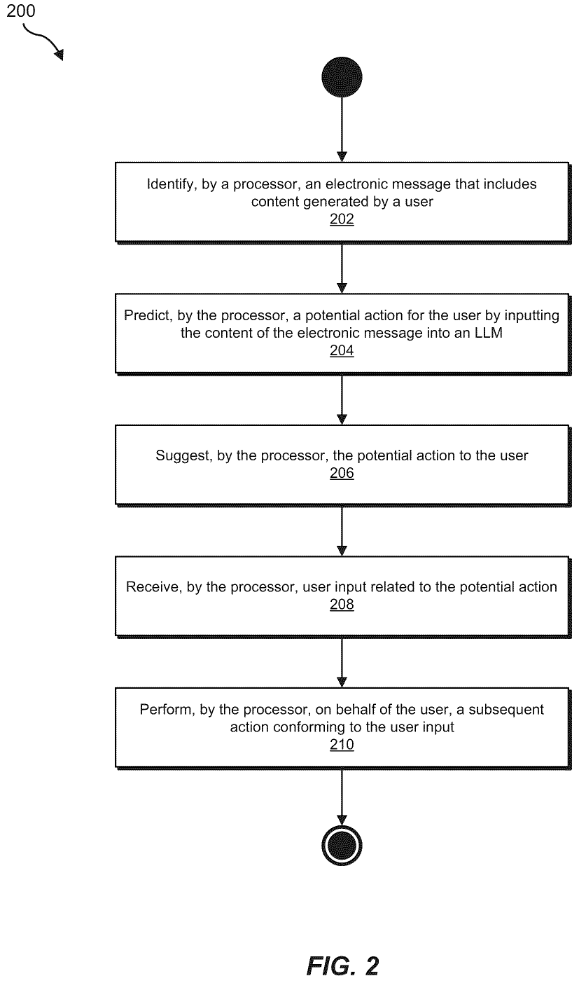

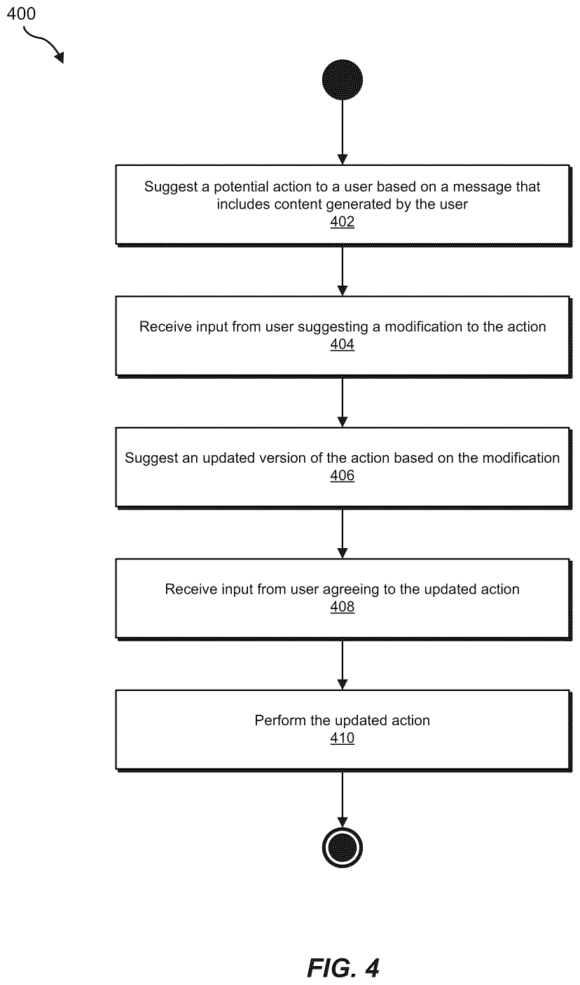

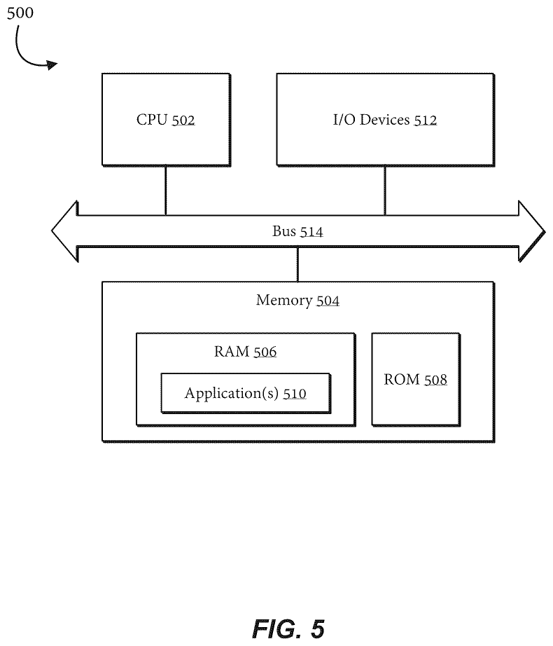

In the various implementations, client device 102, processor 108, and LLM 110 can be implemented using various types of computing devices such as laptop/desktop devices, mobile devices, server computing devices, etc. Specific details of the components of such computer devices are provided in the description of FIG. 5 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the methods described in FIG. 2 and FIG. 4.

In some implementations, electronic message 104 can comprise any digital message that includes text or an audio or video file from which words can be extracted as text, such as a voicemail or video message. Examples of electronic message 104 may include, without limitation, email, instant messages, voicemail, video message, and/or short messaging service messages.

In some implementations, content 106 may include text. For example, content 106 may be the text of an email. Additionally, content 106 may include other types of content such as images, animations, video, links, and/or attachments to a message.

FIG. 2 is a flow diagram illustrating a method for performing message automation according to some of the example embodiments.

In step 202, the method can include identifying, by a processor, an electronic message that comprises content generated by a user.

In some implementations, the method may identify the message as the message is being composed by the user. For example, the method may include monitoring a message-composition app such as an email app or a browser. Additionally, or alternatively, the method may identify a message at the time the message is sent or received. For example, the method may monitor sent messages or messages received at the device or in a user's mailbox. In one implementation, a server may monitor sent messages, analyze the sent message for potential actions, and send information back to the client device from which the message was sent.

In some examples, the content generated by the user may be typed by the user into an electronic message composition interface. Additionally, or alternatively, the content generated by a user may be spoken by a user and then added to the electronic message via a voice-to-speech algorithm. In one example, content generated by the user may be loaded from a template, created by an algorithm, and/or otherwise produced by a computational process that is initiated and/or directed by the user.

In step 204, the method can include predicting, by an LLM executed by the processor, based on the content of the electronic message, a potential action for the user.

In some implementations, the LLM may parse the content to determine whether the content indicates a potential action. For example, an email thanking a friend for a gift may not indicate a potential action while an email inviting a friend to lunch may indicate a potential action of making a lunch reservation at a restaurant and/or adding a lunch event to a calendar. In cases where the LLM determines that the content does not indicate a potential action, the method may cease performing additional steps on the message.

In one implementation, the method may monitor user behavior to learn which types of messages are likely to be associated with actions. For example, if after composing a message with the keyword “follow-up,” the user typically composes another message to be sent at a later time, the method may begin monitoring for the keyword “follow-up” in order to suggest scheduling an additional message. In another example, if after composing a message that includes a date, the user typically creates a calendar event for that date, the method may begin monitoring for dates in messages in order to suggest creating a calendar event.

The LLM may predict one or more potential actions for the user in a variety of ways. For example, the LLM may parse the content of the electronic message for keywords or phrases that indicate types of actions. In one example, the LLM may scan for dates, locations, and so forth.

In some implementations, the LLM may parse text from the message. Additionally, or alternatively, the LLM may process other types of content. For example, an image parser may parse an image into text that the LLM receives as input. Similarly, a video parser may parse a video into text (e.g., captioning, descriptive text, etc.) that the LLM receives as input. In one example, the method may identify an attachment to the message and may provide information about the attachment (e.g., file name, file type, contents, etc.) as input to the LLM. For example, the method may identify an attachment that is a graphic of a birthday party invitation and may predict a potential action of purchasing a birthday cake. As another example, the method can analyze audio (e.g., voice commands or dictation audio) and convert this audio to text before inputting the audio into an LLM.

In some embodiments, the method may prepare a prompt for the LLM and may provide the prompt as input alongside the message, as illustrated in the following example.

Example email: It was nice seeing you yesterday, too! Lunch tomorrow sounds great. We can try that Indian fusion place on 3^{rd} street, Curry And More. I've heard they have really good butter chicken. I'm free at 1 pm if that works for you.

Example prompt: Analyze this email for a potential action being discussed in the email. Look for dates or verbs that indicate future plans. Make note of any names, numerical amounts, or uniform resource locators. Output a suggested action based on the contents of this message. Use concise natural language and phrase the suggestion as a question.

Example output: Do you want to make a reservation at Curry And More for 1 pm tomorrow?

In some implementations, the LLM may be trained on a corpus of training data that includes electronic messages and subsequent actions. Additionally, or alternatively, the LLM may use the user's electronic messages and actions as training data in order to continue adapting to the user's specific needs and preferences. For example, if the user repeatedly sends follow-up emails two days after emailing vendors, the LLM may identify this preference and may suggest the action of scheduling a follow-up email for two days after sending an email to a vendor.

In step 206, the method can include suggesting, by the processor, the potential action to the user.

In some implementations, processor may suggest the potential action by prompting the LLM to generate a summary of the potential action and presenting the summary to the user via a user interface (UI).

Example action: Use the application programming interface of the Curry and More restaurant's website to send a reservation request for two people for an outdoor table for 1 pm on May 16^{th}. Upon receipt of confirmation of the reservation, create a calendar event for 1 pm on May 16^{th} at the location of the Curry and More restaurant and add George to the calendar event via the email address included in the “to” section of the current email.

Example summary: Would you like to make a reservation at Curry and More for tomorrow at 1 μm and invite George to a calendar event for lunch?

The method may use a variety of UI elements. For example, the method may display a pop-up notification asking the user if they would like the potential action performed on their behalf. In another example, the method may prepare the potential action, such as drafting an email, generating additional text for an email, or creating a calendar event, display the prepared action to the user, and ask the user to approve the action. In one example, the method may draft an additional message, create the message, and then display the message with a UI element that prompts the user to accept or reject sending the message.

In step 208, the method can include receiving, by the processor, user input related to the potential action.

In some examples, the user input related to the potential action may indicate the user's agreement to the potential action. In some implementations, the method may receive the user input via a user's interaction with a UI element. For example, a user may click on an “accept” or “approve” button. In another example, a user may send a message drafted by the LLM. In some examples, the user may communicate approval of the action and/or suggested edits to the action to the LLM via text. For example, the LLM may receive the input “send the email Thursday instead” and may schedule the drafted email to be sent on the next Thursday rather than immediately.

In some implementations, the method can include presenting a chat dialog in addition to the suggested actions. In this manner, the user can provide further instructions to the LLM on what actions to take or how to modify the actions as discussed in more detail in FIG. 4.

In step 210, the method can include performing, by the processor, on behalf of the user, a subsequent action conforming to the user input.

In response to the LLM output, the method may perform a variety of actions. For example, the method may add text to an existing message (e.g., the message the user is currently composing), create one or more additional messages, initiate a purchase, and/or create a calendar reminder. In some examples, the method may suggest and then perform multiple potential actions. For example, if a user is composing an email inviting someone to a birthday party, the method may add a birthday event to the user's calendar, send an email reserving a venue, initiate the purchase of a birthday cake, and/or add a “purchase birthday present” item to the user's digital to-do list.

In some implementations, the method may interface with other systems to perform actions. For example, the method may create formatted output that can be used as input to an application programming interface (API) for another application such as a calendar application, reservation application, store application, etc., in order to perform an action. In some implementations, the LLM may be trained or pre-loaded with the correct formatting for communicating with various relevant APIs. Additionally, or alternatively, the method may include passing LLM output to a parser that formats the output appropriately for providing as API input. In some implementations, the processor may perform the potential action based on the output of the LLM. In other implementations, the LLM can be configured to perform the action itself (e.g., via one or more autonomous agents).

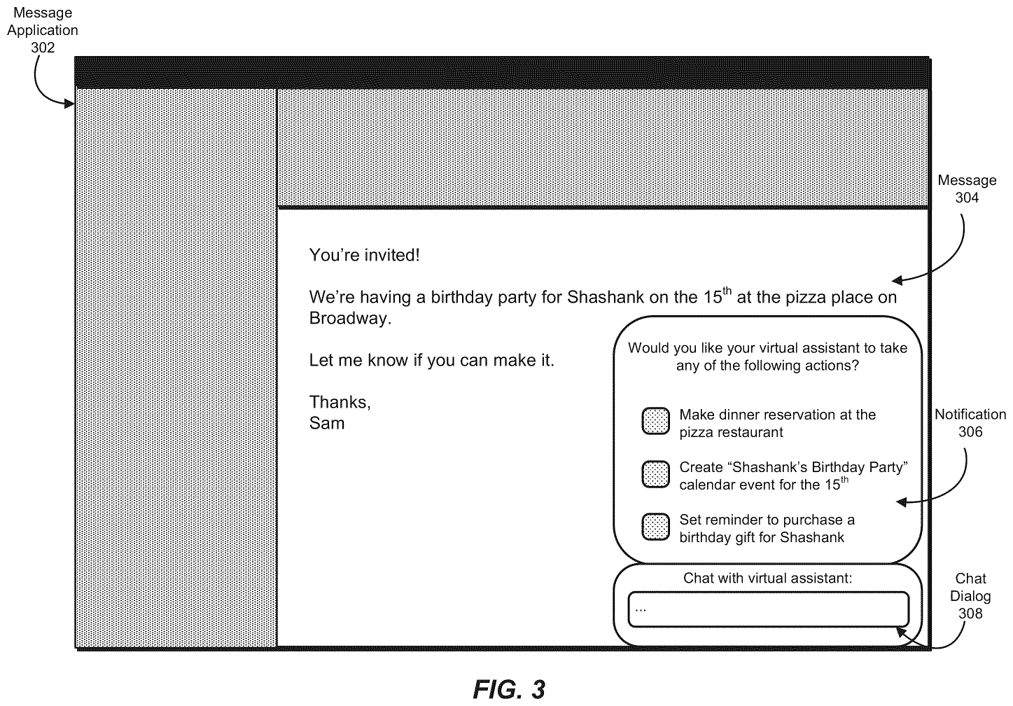

FIG. 3 is an illustration of an example of message automation according to some of the example embodiments.

As illustrated in FIG. 3, in one implementation, the systems described herein may detect a message 304 being composed by a user in a messaging application 302. In response to detecting message 304, an LLM may parse the text of message 304 for identify any potential actions to suggest. Upon detecting that message 304 appears to be related to planning a birthday party, the LLM may suggest the actions of making a reservation at the location named in message 304, creating a calendar event on the date described in message 304, and/or adding a reminder to buy a present for the celebrant named in message 304. In one implementation, the systems described herein may surface these suggestions to the user via a UI element such as notification 306. In some implementations, the UI may include a chat dialog 308 that enables the user to input text commands to the LLM and/or an agent operated by the processor that parses the text commands into prompts for the LLM.

In one example, the user may check one or more boxes on notification 306 to indicate agreement to one or more of the suggested potential actions. For example, the user may check the box to create a calendar event. In this example, the systems described herein may then create a calendar event for the user using the information from message 304.

FIG. 4 is a flow diagram illustrating a method for performing message automation according to some of the example embodiments.

In step 402, the method can include suggesting a potential action based on a message to a user.

In one example, the method may include determining, by an LLM, that a message includes contents requesting an oil change from a car dealer. In this example, the method may suggest additional text for the message that includes requesting a quote for the oil change and requesting a quote for car detailing. Further details on suggesting potential actions using an LLM are provided in the description of FIG. 3 and not repeated herein.

In step 404, the method can include receiving input from the user suggesting a modification to the action.

For example, the user may input text to the LLM via a chat function such as, “no detailing quote but ask about a brake inspection.” In another example, the user may manually edit the text suggested by the LLM. For example, the user may remove the text about requesting a quote for detailing.

In step 406, the method can include suggesting an updated version of the action based on the modification.

In some implementations, the LLM may modify the original action based on the modification suggested by the user. For example, the LLM may remove the text about getting a quote for detailing and add new text about getting a quote for a brake inspection.

In some embodiments, the method may compose a prompt to provide to the LLM as input in order to generate the updated version of the action.

Example suggested action: Send an email to the auto mechanic with the following text: “Hi, you've been recommended to me by my friend. I have a 2000 Mercedes E320. Can I get a quote for an oil change? I would like it to be done by next Friday if possible. I would also like a quote for detailing the car.”

Example user modification: No detailing quote. Ask about brake inspection and combo deals.

Example prompt: Modify the above email by removing the sentence asking about detailing the car. Add a sentence asking about a brake inspection. Add a sentence asking for a combo deal. Match the tone of the original email.

Example output: Send an email to the auto mechanic with the following text: “Hi, you've been recommended to me by my friend. I have a 2000 Mercedes E320. Can I get a quote for an oil change? I would like it to be done by next Friday if possible. I would also like a quote for inspecting both the front and the rear brakes. Would it be possible to get a combo deal since I am requesting two services?”

In step 408, the method can include receiving input from the user agreeing to the updated action.

In one implementation, the LLM may receive input from the user via a UI element such as a button. For example, the user may send the updated message. In another example, the user may click or tap an “agree” button on a notification about the action.

In step 410, the method can include performing the updated action.

For example, the LLM may send the updated message instead of the originally suggested message. In one example, the LLM may send the message with the text about a quote on a brake inspection rather than the message with text about a quote for car detailing.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

1. A method comprising:
identifying, by a processor, an electronic message that comprises content written by a user;
predicting, by the processor, a potential action for the user by inputting the content of the electronic message into a large language model;
suggesting, by the processor, the potential action to the user;
receiving, by the processor, user input related to the potential action; and
performing, by the processor, on behalf of the user, a subsequent action conforming to the user input.

2. The method of claim 1, wherein identifying the electronic messages comprises identifying an electronic message sent by the user.

3. The method of claim 1, wherein identifying the electronic messages comprises identifying an electronic message being composed by the user that has not yet been sent.

4. The method of claim 1, wherein receiving user input related to the potential action comprises receiving a modification of the potential action provided by the user via a chat interface and generating a new potential action using the large language model, wherein performing the subsequent action comprises performing the new potential action.

5. The method of claim 1, wherein performing the subsequent action comprises creating a digital calendar event on behalf of the user.

6. The method of claim 1, wherein performing the subsequent action comprises sending an additional electronic message on behalf of the user.

7. The method of claim 1, wherein performing the subsequent action comprises creating additional content and adding the additional content to the electronic message.

8. The method of claim 1, wherein suggesting the potential action to the user comprises generating, by the large language model, a description of the potential action and displaying the description in a user interface.

9. A non-transitory computer-readable storage medium for tangibly storing computer program instructions capable of being executed by a computer processor, the computer program instructions defining steps of:
identifying, by a processor, an electronic message that comprises content generated by a user;
predicting, by the processor, a potential action for the user by inputting the content of the electronic message into a large language model;
suggesting, by the processor, the potential action to the user;
receiving, by the processor, user input related to the potential action; and
performing, by the processor, on behalf of the user, a subsequent action conforming to the user input.

10. The non-transitory computer-readable storage medium of claim 9, wherein identifying the electronic messages comprises identifying an electronic message sent by the user.

11. The non-transitory computer-readable storage medium of claim 9, wherein identifying the electronic messages comprises identifying an electronic message being composed by the user that has not yet been sent.

12. The non-transitory computer-readable storage medium of claim 9, receiving user input related to the potential action comprises receiving a modification of the potential action provided by the user via a chat interface and generating a new potential action using the large language model, wherein performing the subsequent action comprises performing the new potential action.

13. The non-transitory computer-readable storage medium of claim 9, wherein performing the subsequent action comprises creating a digital calendar event on behalf of the user.

14. The non-transitory computer-readable storage medium of claim 9, wherein performing the subsequent action comprises sending an additional electronic message on behalf of the user.

15. The non-transitory computer-readable storage medium of claim 9, wherein performing the subsequent action comprises creating additional content and adding the additional content to the electronic message.

16. The non-transitory computer-readable storage medium of claim 9, wherein suggesting the potential action to the user comprises generating, by the large language model, a description of the potential action and displaying the description in a user interface.

17. A device comprising:
a processor; and
a storage medium for tangibly storing thereon logic for execution by the processor, the logic comprising instructions for:
identifying, by the processor, an electronic message that comprises content generated by a user;
predicting, by the processor, a potential action for the user by inputting the content of the electronic message into a large language model;
suggesting, by the processor, the potential action to the user;
receiving, by the processor, user input related to the potential action; and
performing, by the processor, on behalf of the user, a subsequent action conforming to the user input.

18. The device of claim 17, wherein identifying the electronic messages comprises identifying an electronic message sent by the user.

19. The device of claim 17, wherein identifying the electronic messages comprises identifying an electronic message being composed by the user that has not yet been sent.

20. The device of claim 17, receiving user input related to the potential action comprises receiving a modification of the potential action provided by the user via a chat interface and generating a new potential action using the large language model, wherein performing the subsequent action comprises performing the new potential action.
